(19) United States
(12) Patent Application Publication
(10) Pub. No.: US 2016/0048202 A1
(43) Pub. Date: Feb. 18, 2016

(54) DEVICE PARAMETER ADJUSTMENT USING DISTANCE-BASED OBJECT RECOGNITION

(71) Applicant: QUALCOMM Incorporated, San Diego, CA (US)

(72) Inventors: Insoo Hwang, San Diego, CA (US); Bongyong Song, San Diego, CA (US); Onur Canturk Hamsici, San Diego, CA (US)

(21) Appl. No.: 14/459,110

(22) Filed: Aug. 13, 2014

(51) Int. Cl. G06F 3/01; G06K 9/00

(52) U.S. Cl. CPC G06F 3/012; G06K 9/00255; G06K 9/00281; G06K 9/00261; G06K 9/00248

(57) ABSTRACT

Methods, systems, and devices are described that provide for parameter adjustment for devices. A device may register a user profile associated with a user. During registration an image of the user may be captured and analyzed, such as to determine a size of facial features for the user. Also, during registration, metrics may be input or determined such as the age of the user or any sensory sensitivities. The device may capture a second image of the user. The second image may be compared to the first in order to determine the current distance between the user's face and the device. Comparing the first and second image may include comparing the size of corresponding facial features in each image, such as measured in pixels. Multiple images may be used for the first or second images. Based on contextual conditions and the distance, the device may adjust a sensory-related parameter.

### BACKGROUND

1. Field of the Disclosure

The following relates generally to devices, and in particular, to devices having outputs that may be adjusted.

2. Description of Related Art

Mobile devices are used for a number of tasks such as making calls, viewing images, watching movies, browsing the internet, etc. Mobile devices are becoming more and more prevalent, as is the reliance on large vivid screens as part of the mobile devices. With more people viewing mobile devices for longer periods of time, it is becoming increasingly important to consider the ramifications of such interactions. It may be desirable to limit or reduce exposure to mobile devices.

### SUMMARY

Described below are methods, systems, and devices that provide for parameter adjustment for devices. A device may register a user profile associated with a user. During the registration a distance from the user to the device may be calculated. Further, an image of the user may be captured and analyzed. The image may be used to determine a size of facial features for the user. Also, during registration, metrics may be input or determined such as the age of the user or any sensory sensitivities. Contextual conditions may be monitored, such as if the user profile belongs to a profile category, if an application belonging to an application category is being interacted with, and/or if a distance between the user's face and the device is less than a distance threshold. Based on the contextual conditions, the device may capture a second image of the user. The second image may be compared to the first in order to determine the current distance between the user's face and the device. More than two images may be captured and used for distance estimation. Based on the contextual condition and the distance, the device may adjust a sensory-related parameter. The distance may be calculated as a time average of a number of distances. Further, comparing the first and second image may include comparing the size of corresponding facial features in each image. Facial feature size can be estimated by counting digital image elements (e.g., pixels, dots, etc.). In some cases, a mean facial feature size is determined and facial features may be weighted differently when determining the mean facial feature size. For example, facial features with less variance may be given a greater weight than highly variable facial features such as a mouth.

In some examples, a method of adjusting a sensory-related parameter of a device includes determining that a contextual condition has been satisfied, determining a distance between a user's face and the device, and adjusting the sensory-related parameter of the device based in part on the distance and the contextual condition.

In some examples, a device having an adjustable sensory-related parameter includes means for determining that a contextual condition has been satisfied, means for determining a distance between a user's face and the device, and means for adjusting the sensory-related parameter of the device based in part on the distance and the contextual condition.

In some examples, a device having an adjustable sensory-related parameter includes a processor, memory in electronic communication with the processor, and instructions stored in the memory. The instructions may be executable by the processor to determine that a contextual condition has been satisfied, determine a distance between a user's face and the device, and adjust the sensory-related parameter of the device based in part on the distance and the contextual condition.

In some examples, a non-transitory computer readable medium stores computer-executable code for adjusting a sensory-related parameter in a wireless device. The code may be executable by a processor to determine that a contextual condition has been satisfied, determine a distance between a user's face and the device, and adjust the sensory-related parameter of the device based in part on the distance and the contextual condition.

Various examples of the method, devices, and/or non-transitory computer readable medium may include the features of, means for, processor-executable instructions for, and/or processor-executable code for registering a user profile associated with the user. In some cases, the sensory-related parameter of the device is adjusted linearly or logarithmically with respect to the distance. The sensory-related parameter may be at least one of a display brightness, a screen resolution, a zoom, and a volume. Determining the distance may include determining a time average of a number of distances. In some cases, registering a user profile includes capturing at least one first image of the user, and determining at least one metric for the user. The at least one metric may be at least one of a user designation and a size of at least one facial feature.

Various examples of the method, devices, and/or non-transitory computer readable medium may include the features of, means for, processor-executable instructions for, and/or processor-executable code for determining a first distance. In some cases, determining the first distance is based in part on at least one of a sensor output and analysis of the at least one first image of the user.

Various examples of the method, devices, and/or non-transitory computer readable medium may include the features of, means for, processor-executable instructions for, and/or processor-executable code for determining a first feature size for a number of facial features in the at least one first image. In some cases, determining the first feature size is based in part on a first number of pixels occupied by the facial feature. Determining the distance between the user's face and the device may include capturing at least one second image of the user, determining a second feature size for the number of facial features in the at least one second image, and determining the distance between the user's face and the device based in part on a comparison of the first feature size for the number of facial features and the second feature size for the number of facial features. In some cases, comparing the first feature size for the number of facial features and the second feature size for the number of facial features is based in part on a weight associated with at least one of the number of facial features. Determining the second feature size may be based in part on a second number of pixels occupied by the facial feature. The contextual condition being satisfied may include at least one of the user profile belonging to a profile category, interaction with an application belonging to an application category, and the distance between the user's face and the device being less than a threshold. In some cases, the profile category includes at least one user profile which is subject to sensory-related parameter adjustment. The application category may include at least one application which is subject to sensory-related parameter adjustment.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a wireless communications system in accordance with various aspects of the present disclosure;

FIG. 2 shows an illustration of an example wireless communication system in accordance with various aspects of the present disclosure;

FIGS. 3A and 3B show an illustration of an example distance determination system in accordance with various aspects of the present disclosure;

FIGS. 4A and 4B show block diagrams of an example device(s) that may be employed in wireless communications systems in accordance with various aspects of the present disclosure;

FIG. 5 shows a block diagram of a device configured for parameter adjustment in accordance with various aspects of the present disclosure;

FIG. 6 shows a block diagram of a communications system that may be configured for parameter adjustment in accordance with various aspects of the present disclosure; and

FIGS. 7, 8, and 9 are flow diagrams that depict a method or methods of parameter adjustment in accordance with various aspects of the present disclosure.

### DETAILED DESCRIPTION

As mobile devices become more and more capable, the outputs of mobile devices may be improved to include, for example, larger and brighter screens, louder speakers, increased tactile feedback such as vibrations, etc. As outputs are improved, it may be important to limit or otherwise adjust the outputs in order to safeguard the health of the mobile device user—so that the improved or enhanced outputs don't harm the user. Thus, as outputs are improved, it may be important to limit the outputs for certain applications, for certain users of the devices, or when the devices are at certain distances from the user. For example, there may be long-term physical ramifications to children who spend too much time with bright screens and loud noises coming from mobile devices at close range. Therefore, a device that adjusts one or more parameters relating to its outputs in response to various sensed conditions may be beneficial. Thus, parameter adjustment for devices is described.

Parameter adjustment of a device may be user specific. Therefore, parameter adjustment of a device may include registering a user profile associated with a user. By registering a user profile, the device may be made aware of user preferences, such as what parameters to change for a particular user and under what circumstances the parameters should be changed. For example, it may be preferred to only perform parameter adjustments for young users, such as younger than sixteen, or users with specific sensory sensitivities, as these users may be more susceptible to negative impacts of device interaction. During the user profile registration, an image of the user may be captured and analyzed to determine the distance at which the image was captured. The image may further be used to determine a size of facial features for the user at that distance. These determinations, made during user registration, may be used during later use by the user of the device to determine if certain sensory-related thresholds have been crossed and thus whether parameter adjustments should be made.

During use of the device by a user, a second image may be captured to determine the current distance between the user's face and the device. Based on various user-profile-defined conditions and the determined distance between the user and the device, the device may adjust one or more sensory-related parameters such as screen brightness.

The determined distance may be determined by comparing the size of facial features included in both the first and the second images. Comparing the first and second images may include comparing the number of pixels used to represent specific facial features. In some cases, a mean facial feature size may be determined and specific facial features may be weighted differently when determining the mean facial feature size. For example, facial features with less variance may be given a greater weight than highly variable facial features such as a mouth, so as to reduce issues which arise from users making facial expressions.

Thus, the following description provides examples, and is not limiting of the scope, applicability, or configuration set forth in the claims. Changes may be made in the function and arrangement of elements discussed without departing from the spirit and scope of the disclosure. Various examples may omit, substitute, or add various procedures or components as appropriate. For instance, the methods described may be performed in an order different from that described, and various steps may be added, omitted, or combined. Also, features described with respect to certain examples may be combined in other examples.

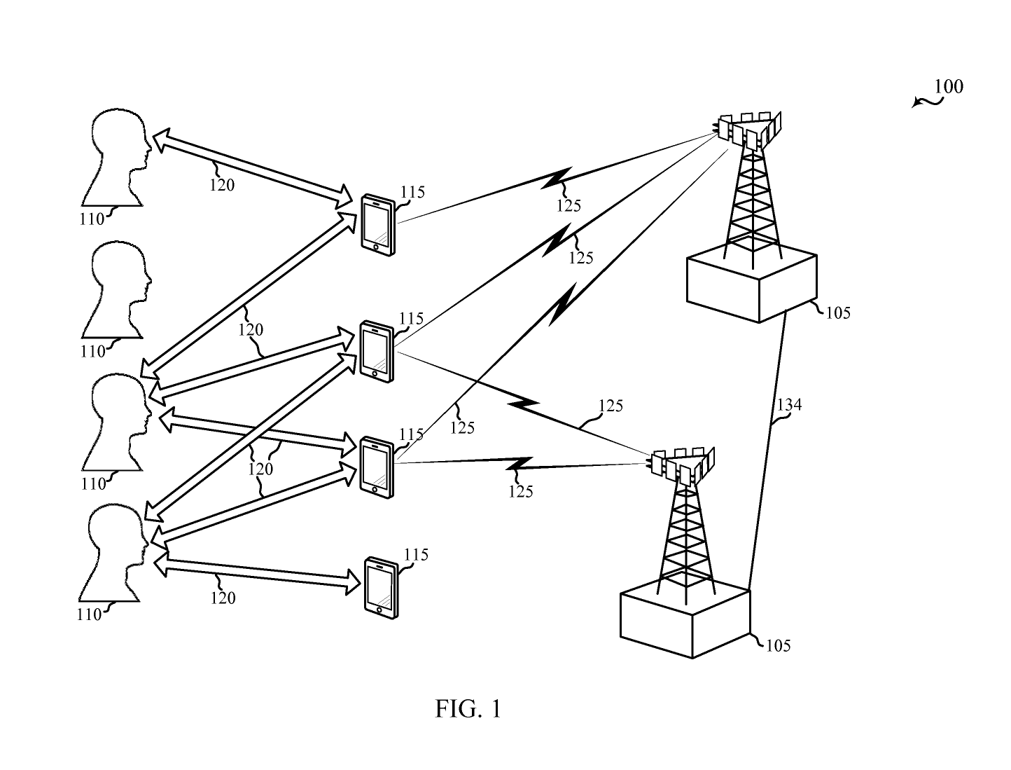

FIG. 1 depicts an example of a parameter adjustment system 100 in accordance with various aspects of the present disclosure. The system 100 provides for adjustments of parameters of devices 115. The parameter adjustment system 100 may include a plurality of base stations 105 (e.g., evolved NodeBs (eNBs), wireless local area network (WLAN) access points, or other access points), a number of devices 115, and a number of users 110. Some of the base stations 105 may communicate with the devices 115 under the control of a base station controller (not shown), which may be part of a core network or certain ones of the base stations 105 in various examples. Some of the base stations 105 may communicate control information and/or user data with the core network. In some examples, some of the base stations 105 may communicate, either directly or indirectly, with each other over backhaul links 134, which may be wired or wireless communication links. The system 100 may be a multi-carrier long-term evolution (LTE) network capable of efficiently allocating network resources, or may be some other type of wireless network such as a WLAN.

The base stations 105 may wirelessly communicate with the devices 115 via one or more base station antennas. Each of the base stations 105 may provide communication coverage for a respective coverage area. In some examples, a base station 105 may be referred to as an access point, a base transceiver station (BTS), a radio base station, a radio transceiver, a basic service set (BSS), an extended service set (ESS), a NodeB, an evolved NodeB (eNB), a Home NodeB, a Home eNodeB, a WLAN access point, a WiFi node or some other suitable terminology. The wireless communication system 100 may include base stations 105 of different types (e.g., macro, micro, and/or pico base stations). The base stations 105 may also utilize different radio technologies, such as cellular and/or WLAN radio access technologies. The base stations 105 may be associated with the same or different access networks or operator deployments. The coverage areas of different base stations 105, including the coverage areas of the same or different types of base stations 105, utilizing the same or different radio technologies, and/or belonging to the same or different access networks, may overlap.

The devices 115 may be dispersed throughout the parameter adjustment system 100, and each device 115 may be stationary or mobile. A device 115 may also be referred to by those skilled in the art as a user equipment (UE), a mobile station, a subscriber station, a mobile unit, a subscriber unit, a wireless unit, a remote unit, a wireless device, a wireless communication device, a remote device, a mobile subscriber station, an access terminal, a mobile terminal, a wireless terminal, a remote terminal, a handset, a user agent, a mobile client, a client, or some other suitable terminology. A device 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, a television, an advertisement, a display, or the like. It should be noted that in some cases a device 115 is a mobile device while in some cases a device 115 is a fixed or stationary device. A device 115 may be able to communicate with macro eNBs, pico eNBs, femto eNBs, relays, and the like. A device 115 may also be able to communicate over different types of access networks, such as cellular or other wireless wide area network (WWAN) access networks, or WLAN access networks. In some modes of communication with a device 115, communication may be conducted over a plurality of communication links 125 or channels (i.e., component carriers), with each channel or component carrier being established between the device and one of a number of cells (e.g., serving cells, which in some cases may be different base stations 105).

The communication links 125 shown in parameter adjustment system 100 may include uplink channels (or component carriers) for carrying uplink (UL) communications (e.g., transmissions from a device 115 to a base station 105) and/or downlink channels (or component carriers) for carrying downlink (DL) communications (e.g., transmissions from a base station 105 to a device 115). The UL communications or transmissions may also be called reverse link communications or transmissions, while the DL communications or transmissions may also be called forward link communications or transmissions.

The users 110 may interact 120 with a number of devices 115. The interaction 120 between a user 110 and a device 115 may include input from the user 110 to the device 115 and/or output from the device 115 to the user 110. Inputs may include physical interaction such as a button push or contact with a touch screen. Further inputs may include sensor inputs at the device 115 such as from proximity sensors, cameras, accelerometers, microphones, or other suitable input. Output from the device may include sounds from a speaker, objects displayed on a display screen, tangible changes such as vibration, or other suitable output. A number of users 110 may interact with a single device 115 and/or a single user 110 may interact with a number of devices 115. In some cases, a single user 110 interacts with a single device 115. A device 115 which interacts with multiple users 110 may include a number of user profiles associated with at least one user 110 each or may include a single profile which corresponds with a number of the multiple users 110. User information may be communicated from a device 115 to a base station 105, such as for storing information relating to the user 110 on a network. In some cases, devices 115 do not communicate with base stations 105 and/or may store information relating to users 110 locally.

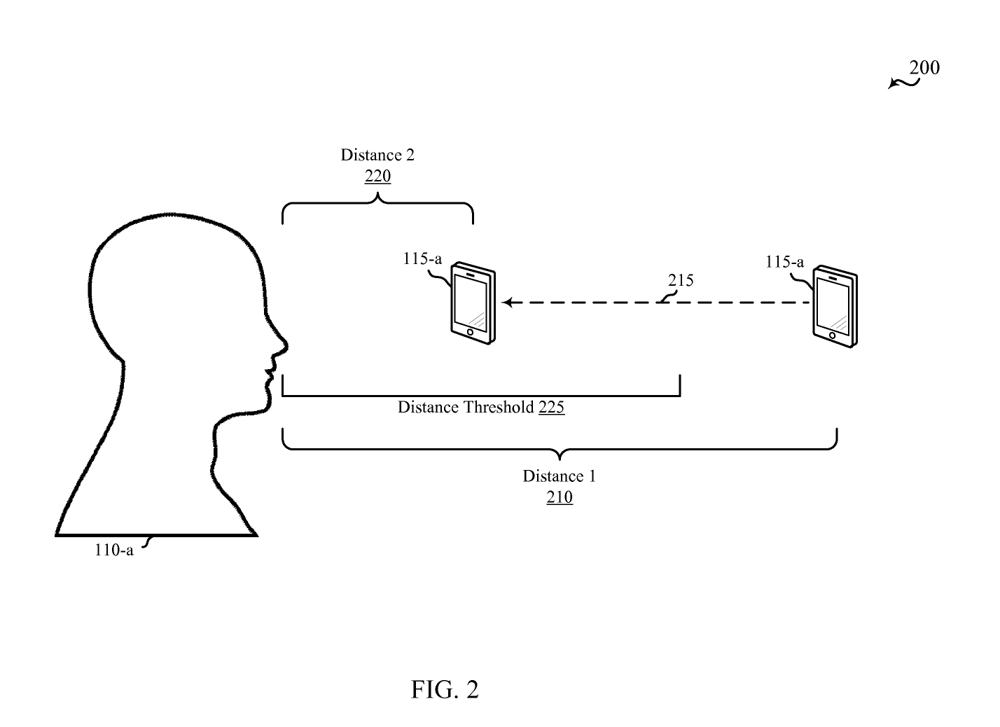

FIG. 2 shows a diagram illustrating an example of a parameter adjustment system 200 in accordance with various aspects of the present disclosure. The parameter adjustment system 200 includes a device 115-a and a user 110-a. The user 110-a may be an example of the users 110 of FIG. 1. The device 115-a may be an example of the devices 115 of FIG. 1.

The system 200 may include a device 115-a with a registered profile associated with a user 110-a. In some cases, the device 115-a may recognize the user 110-a and activate the associated user profile based on the recognition. The device 115-a may recognize the user 110-a in a variety of ways, such as by the user 110-a logging in or the device 115-a recognizing the user 110-a based on an image or other sensors. The device 115-a may be located at a first distance 210 from the user 110-a. The device 115-a may determine the first distance 210, such as through analyzing a number of pictures, or through sensors. In some cases, the device 115-a may determine that the first distance 210 is greater than a threshold distance 225, and may not spend extra resources determining the specific distance.

At some point, the device 115-a may transition 215 from the first distance 210 to a second distance 220, such as a distance closer to the user 110-a. The second distance 220 may be located closer to the user 110-a than a threshold distance 225. The device 115-a may determine the second distance 220, such as through analyzing a number of images of the user 110-a at the second distance 220 or comparing a number of images of the user at the second distance 220 with a number of images of the user 110-a at a known distance (such as during a user registration).

When the device 115-a is moved to be within a threshold distance 225 of a user 110-a, then parameter adjustment of the device 115-a may occur. Contextual conditions may be used to determine when parameter adjustment is desired. For example, parameter adjustment may not be used for all users of a device, but may be activated when a child is using the device 115-a. In some cases, only certain applications which may provide stimulating outputs to the senses may be subject to parameter adjustment. Further, parameter adjustment may only be preferred when the device 115-a is close to a user's 110-a face.

The device 115-a may determine that at least one contextual condition has been satisfied. A first contextual condition may include determining that the user 110-a (or a profile associated with the user) belongs to a profile category. For example, a profile category may include users under a certain age, such as sixteen. Another profile category may include users with sensitivities, such as sensitive eyes or ears. Further, a profile category may include users with specific privileges, such as viewing or listening privileges. In some cases, information relating to potential profile categories of a user 110 may be collected, such as during a profile registration.

Another contextual condition may include determining that an active application or output of the device 115-a belongs to an application category. An application category may include applications with potentially harmful outputs, such as loud noises or bright lights. Another application category may include applications with restricted access. Further, an application category may include applications which tend to be viewed or listened to closely, such as games or applications with video components, or a lot of detail.

A contextual condition may also include determining that the second distance 220 has crossed the threshold distance 225. The second distance 220 may be determined by sensors on the device 115-a, such as infrared (IR) sensors. In some cases, the second distance 220 is determined by comparing an image of the user 110-a captured at the second distance with another image of the user 110-a (such as an image captured during a user registration).

In some cases, a number of contextual conditions must be satisfied, such as a user profile belonging to a profile category, an active application belonging to an application category, and a distance breaching a distance threshold. If the relevant contextual conditions have been satisfied, the device 115-a may perform parameter adjustment. For example, parameter adjustment may include changing the brightness of the screen, volume of the speakers, resolution of the screen, zoom of the screen, colors represented on the screen, a range (such as a pitch range) of sounds from the speakers, a temperature of the device 115-a, vibration of the device 115-a, or other such sensory-related parameters. The parameter adjustment may be related, such as proportional or inversely proportional, to another quantity such as the distance which the second distance 220 has breached the threshold distance 225. For example, the screen brightness may decrease once the distance to the device 115-a has breached the threshold distance 225, and may continue to decrease (such as linearly, logarithmically, exponentially, etc.) as the distance between the user 110-a and the device 115-a continues to decrease. In some examples, distance computation is linear. Parameter adjustment may be linear with respect to distance, which may lead to quick changes in a parameter, but may cause issues, such as instant blinking on/off, without a protection mechanism, such as hysteresis. Parameter adjustment may be logarithmic with respect to distance, which may lead to slow parameter adjustments, but may be adequate for repeated changes in distance. In some cases, the parameter(s) adjusted may vary depending on the contextual conditions satisfied. For example, if someone is hard of hearing, a parameter adjustment may include reducing the screen brightness as the device 115-a is brought closer to the user 110-a, yet not adjusting the volume of the speakers.

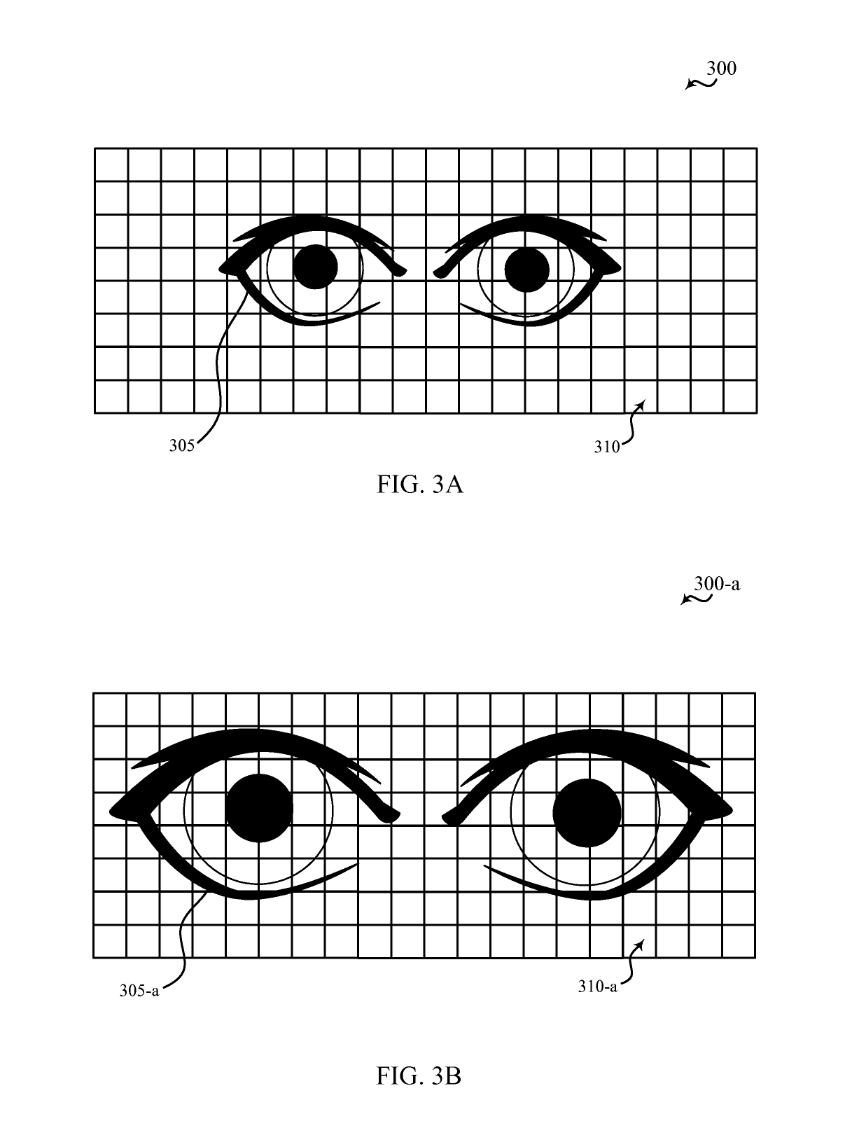

FIGS. 3A and 3B show illustrations of an example system 300 and 300-a of determining a distance between a user and user device or a difference in distance over time between a user and user device in accordance with various aspects of the present disclosure. In systems 300 and 300-a, an image acquired at a first distance between the device and a user may be used in determining the distance between the device and the user when a second image of the user is acquired. Thus, the systems 300 and 300-a may include analyzing at least two images, such as images captured using the camera of a device 115. In some cases, a first image 305 may be captured during a user profile registration. At times, the first image 305 is captured with a device 115 at a known distance from a user 110, such as two feet. In some cases, the first image 305 is captured while sensor data is analyzed, so as to determine a distance between the user 110 and the device 115. The first image 305 may be captured with an object of known size, such as a quarter, held, for example, by the user next to the user's face 110. In some examples, multiple images of the user may be taken at approximately the same distance, or at different distances, and may serve as the first image 305. The multiple images may be captured in different conditions, such as different lighting or at different tilts to more accurately analyze the user's features.

The first image 305 may be used to determine the size of at least one feature of a user 110 at a known distance. For example, a first image 305 may have pixels 310 analyzed to determine the size of facial features, such as measured in pixels or dots. In some cases, a number of facial features may be analyzed. Facial features may include eyebrows, eyes, nose, mouth, ears, chin, cheeks, or any other discernible feature of a user. In some cases, it may be preferential to use facial features which have a low variance in size, such as a nose or eyebrows, as opposed to eyes or mouth which may greatly fluctuate in size. In some examples, an average may be taken across a plurality of features. While taking an average, weights may be associated with features, such as based on their potential size variance.

A second image 305-a may be captured at a second distance. The second image 305-a may be analyzed to determine the second distance. At times, the second distance may be determined relative to the first distance. Additionally or alternatively, the second distance may be determined absolutely, such as if the first distance is known. The second image 305-a may be analyzed to determine a difference in a number of pixels 310-a for a facial feature in the second image 305-a compared to the number of pixels 310 comprising the corresponding facial feature in the first image 305. As discussed above, the comparison may occur for a number of facial features and/or for a weighted average of facial features. In some examples, a number of images of the user may be taken at approximately the same distance, or at different distances, and may serve, individually or collectively, as the second image 305-a.

Based on the comparison of the second set of pixels 310-a to the first set of pixels 310, a relative distance may be determined. If the value of the first distance is known, an absolute value of the second distance may be determined. For example, a square root of the ratio of feature pixels in the second image 305-a relative to the feature pixels in the first image 305 may be used to determine the relative distance at the second distance. This value may become the absolute second distance if multiplied by the first distance. In some cases, a weighted average may be taken of a plurality of second distances, each based, for example, on different facial features. The distance may be monitored or updated in real-time, quasi real-time, periodically, or at chosen times based on the desired results and/or processing power of the device. A time average, such as by using independent and identically distributed (i.i.d.) filtering, may be used.

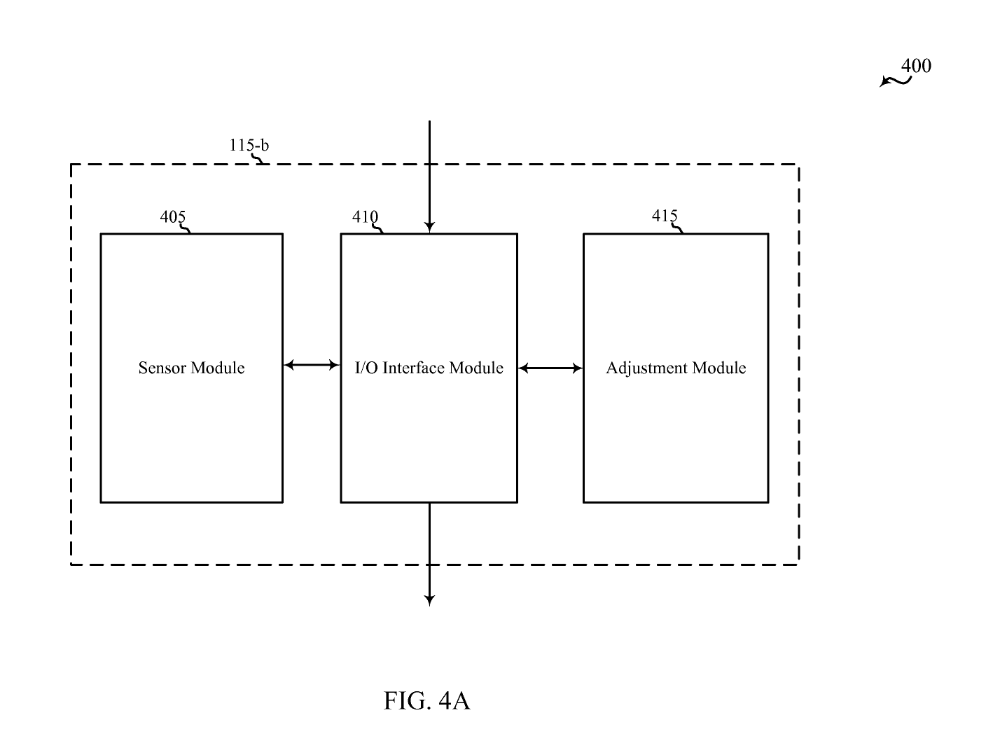

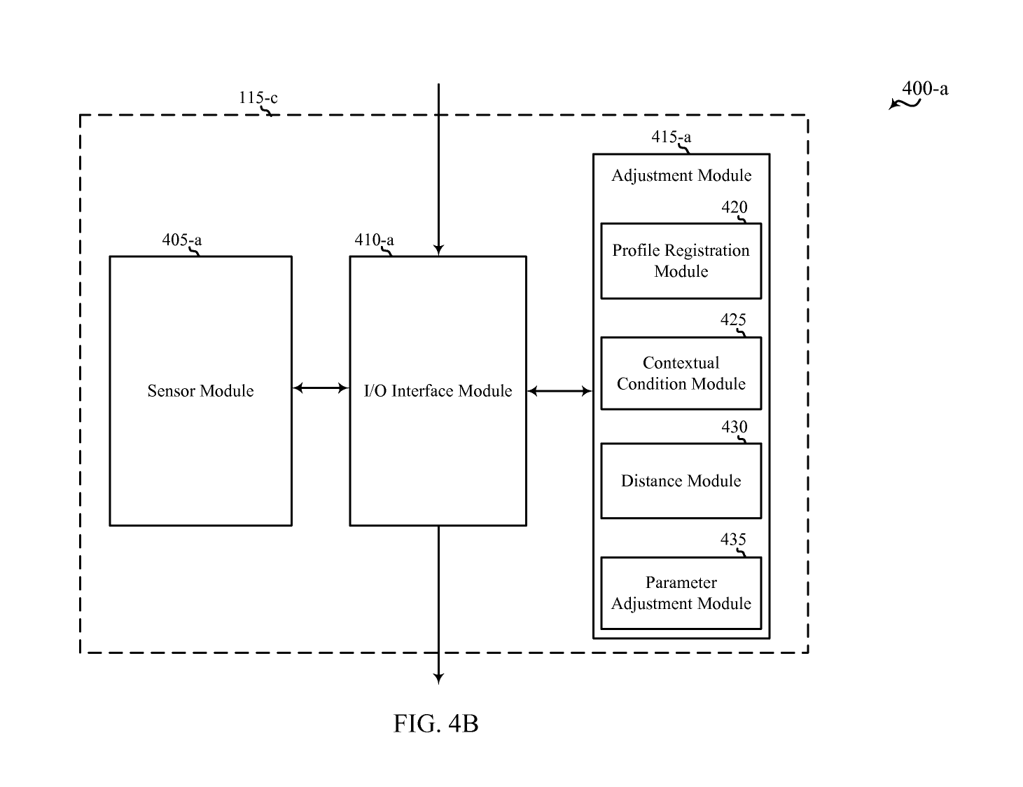

FIG. 4A shows a block diagram illustrating a device 400 configured for parameter adjustment in accordance with various aspects of the present disclosure. The device 400 may be a device 115-b, which may be an example of a device 115 of FIGS. 1 and/or 2. In some examples, the device 400 is a processor. The device 400 may include a sensor module 405, an input/output (I/O) interface module 410, and/or an adjustment module 415. In some cases, the I/O interface module 410 is multiple modules, such as a module for input and a module for output. The I/O interface module 410 may include a single, or multiple, transceiver module(s). The I/O interface module 410 may include an integrated processor; it may also include an oscillator and/or a timer. The I/O interface module 410 may transmit/receive signals or information to/from base stations 105, devices 115, and/or users 110. The I/O interface module 410 may perform operations, or parts of operations, of the systems described above in FIG. 1, 2, 3A, or 3B, including receiving user 110 input, outputting information to a user 110, transmitting or receiving information from a base station 105, and/or transmitting or receiving information from a device 115.

The device 400 may include a sensor module 405. The sensor module 405 may include an integrated processor. The sensor module 405 may include sensors such as distance sensors, cameras, accelerometers, or other suitable sensors. The sensor module 405 may detect a distance to a user 110. In some cases, the sensor module 405 may capture images, such as of the user 110.

The device 400 may include an adjustment module 415. The adjustment module 415 may include an integrated processor. The adjustment module 415 may register a profile for a user 110. The adjustment module 415 may determine that a contextual condition has been satisfied. The adjustment module 415 may determine a distance to a user 110, such as based on an image captured using the sensor module 405. Further, the adjustment module 415 may adjust a parameter, such as a sensory related parameter, of the device 115-b, for example to be output using the I/O interface module 410. The adjustment module 415 may include a database. The database may store information relating to the device 115-b or users 110.

By way of illustration, the device 400, through the sensor module 405, the I/O interface module 410, and the adjustment module 415, may perform operations, or parts of operations, of the system described above with reference to FIGS. 1, 2, 3A, and/or 3B, including registering a user profile, determining a contextual condition has been satisfied, capturing an image of a user at a second distance, determining the second distance, and adjusting a parameter based on the second distance.

FIG. 4B shows a block diagram of a device 400-a configured for parameter adjustment in accordance with various aspects of the present disclosure. The device 400-a may be an example of the device 400 of FIG. 4A; and the device 400-a may perform the same or similar functions as described above for device 400. In some examples, the device 400-a is a device 115-c, which may include one or more aspects of the devices 115 described above with reference to any or all of FIGS. 1, 2, 3A, 3B, and 4A. The device 400-a may also be a processor. In some cases, the device 400-a includes a sensor module 405-a, which may be an example of the sensor module 405 of FIG. 4A; and the sensor module 405-a may perform the same or similar functions as described above for sensor module 405. In some cases, the device 400-a includes an I/O interface module 410-a, which may be an example of the I/O interface module 410 of FIG. 4A; and the I/O interface module 410-a may perform the same or similar functions as described above for I/O interface module 410.

In some examples, the device 400-a includes an adjustment module 415-a, which may be an example of the adjustment module 415 of FIG. 4A. The adjustment module 415-a may include a profile registration module 420. The profile registration module 420 may perform operations, or parts of operations, of the systems described above in FIGS. 1, 2, 3A, and/or 3B, such as registering a user profile, determining a first distance, determining a feature size, determining a feature distance, and/or determining relevant profile categories.

In some examples, the device 400-a includes a contextual condition module 425. The contextual condition module 425 may perform operations, or parts of operations, of the systems described above in FIGS. 1, 2, 3A, and/or 3B, such as determining that a number of contextual conditions have been satisfied, determining application categories, determining a distance threshold, and/or determining relevant profile categories.

In some examples, the device 400-a includes a distance module 430. The distance module 430 may perform operations, or parts of operations, of the systems described above in FIGS. 1, 2, 3A, and/or 3B, such as determining a first distance, determining a second distance, determining a feature distance, determining a mean feature distance, and/or determining a distance threshold.

In some examples, the device 400-a includes a parameter adjustment module 435. The parameter adjustment module 435 may perform operations, or parts of operations, of the systems described above in FIGS. 1, 2, 3A, and/or 3B, such as determining a number of contextual conditions have been satisfied, determining a number of parameters to adjust, and/or adjusting a number of parameters.

According to some examples, the components of the devices 400 and/or 400-a are, individually or collectively, implemented with at least one application-specific integrated circuit (ASIC) adapted to perform some or all of the applicable functions in hardware. In other examples, the functions of device 400 and/or 400-a are performed by at least one processing unit (or core), on at least one integrated circuit (IC). In other examples, other types of integrated circuits are used (e.g., Structured/Platform ASICs, field-programmable gate arrays (FPGAs), and other Semi-Custom ICs), which may be programmed in any manner known in the art. The functions of each unit may also be implemented, in whole or in part, with instructions embodied in a memory, formatted to be executed by at least one general or application-specific processor.

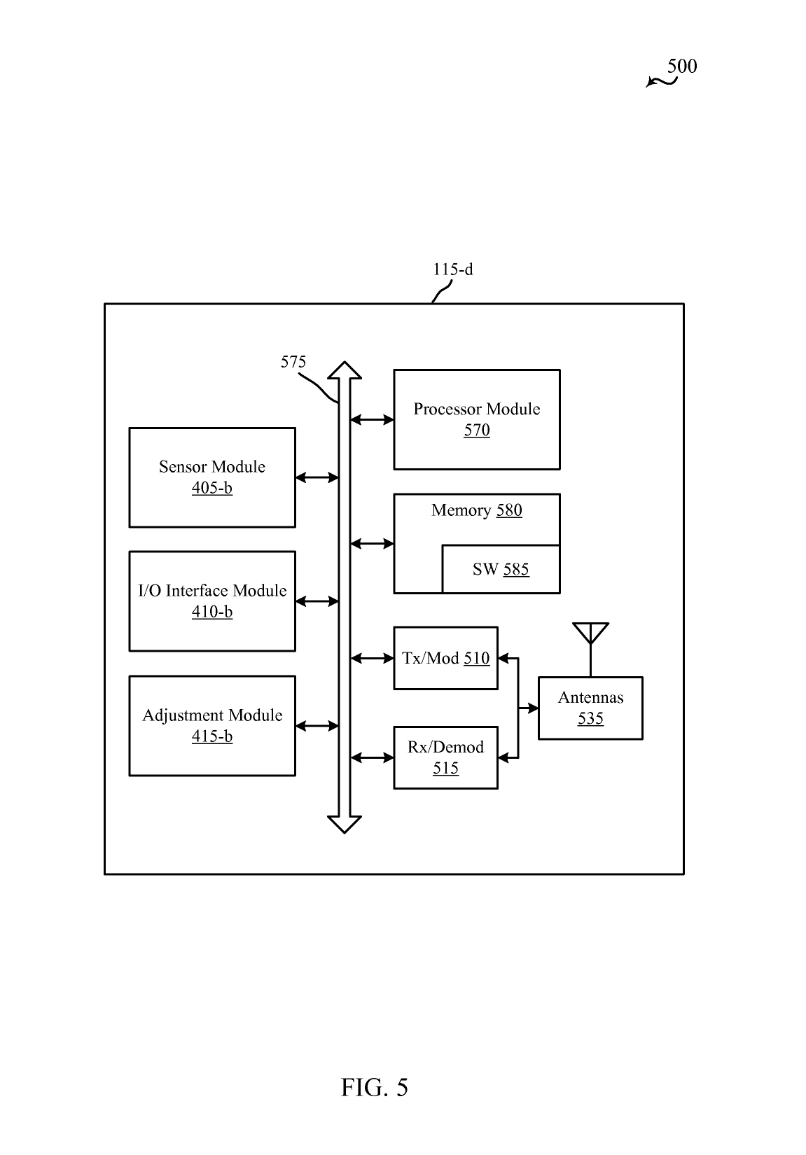

FIG. 5 is a block diagram 500 of a device 115-d configured for parameter adjustment, in accordance with various aspects of the present disclosure. The device 115-d may have any of various configurations, such as personal computers (e.g., laptop computers, netbook computers, tablet computers, etc.), cellular telephones, PDAs, smartphones, digital video recorders (DVRs), internet appliances, gaming consoles, e-readers, etc. The device 115-d may have an internal power supply (not shown), such as a small battery, to facilitate mobile operation. In some examples, the device 115-d may be an example of the devices 115 of FIGS. 1, 2, 3A, 3B, 4A and/or 4B.

The device 115-d may generally include components for bi-directional voice and data communications including components for transmitting communications and components for receiving communications. The device 115-d may include a processor module 570, a memory 580, transmitter/modulators 510, receiver/demodulators 515, and one or more antenna(s) 535, which each may communicate, directly or indirectly, with each other (e.g., via at least one bus 575). The device 115-d may include multiple antennas 535 capable of concurrently transmitting and/or receiving multiple wireless transmissions via transmitter/modulator modules 510 and receiver/demodulator modules 515. For example, the device 115-d may have X antennas 535, M transmitter/modulator modules 510, and R receiver/demodulators 515. The transmitter/modulator modules 510 may be configured to transmit signals via at least one of the antennas 535 to base stations 105 and/or other devices 115. The transmitter/modulator modules 510 may include a modem configured to modulate packets and provide the modulated packets to the antennas 535 for transmission. The receiver/demodulators 515 may be configured to receive, perform RF processing, and demodulate packets received from at least one of the antennas 535. In some examples, the device 115-g may have one receiver/demodulator 515 for each antenna 535 (i.e., R=X), while in other examples R may be less than or greater than X. The transmitter/modulators 510 and receiver/demodulators 515 may be capable of concurrently communicating with multiple base stations 105 and/or devices 115 via multiple-input multiple-output (MIMO) layers and/or component carriers.

According to the architecture of FIG. 5, the device 115-d may also include sensor module 405-b. By way of example, sensor module 405-b may be a component of the device 115-d in communication with some or all of the other components of the device 115-d via bus 575. Alternatively, functionality of the sensor module 405-b may be implemented as a component of the transmitter/modulators 510, the receiver/demodulators 515, as a computer program product, and/or as at least one controller element of the processor module 570.

According to the architecture of FIG. 5, the device 115-d may also include I/O interface module 410-b. By way of example, I/O interface module 410-b may be a component of the device 115-d in communication with some or all of the other components of the device 115-d via bus 575. Alternatively, functionality of the I/O interface module 410-b may be implemented as a component of the transmitter/modulators 510, the receiver/demodulators 515, as a computer program product, and/or as at least one controller element of the processor module 570.

According to the architecture of FIG. 5, the device 115-d may also include adjustment module 415-b. By way of example, adjustment module 415-b may be a component of the device 115-d in communication with some or all of the other components of the device 115-d via bus 575. Alternatively, functionality of the adjustment module 415-b may be implemented as a component of the transmitter/modulators 510, the receiver/demodulators 515, as a computer program product, and/or as at least one controller element of the processor module 570.

The memory 580 may include random access memory (RAM) and read-only memory (ROM). The memory 580 may store computer-readable, computer-executable software/firmware code 585 containing instructions that are configured to, when executed, cause the processor module 570 to perform various functions described herein (e.g., determine a contextual condition has been satisfied, determine a first distance, determine a second distance, determine a feature size, adjust a parameter, etc.). Alternatively, the software/firmware code 585 may not be directly executable by the processor module 570 but be configured to cause a computer (e.g., when compiled and executed) to perform functions described herein.

The processor module 570 may include an intelligent hardware device, e.g., a central processing unit (CPU), a microcontroller, an application-specific integrated circuit (ASIC), etc. The device 115-d may include a speech encoder (not shown) configured to receive audio via a microphone, convert the audio into packets (e.g., 20 ms in length, 30 ms in length, etc.) representative of the received audio, provide the audio packets to the transmitter/modulator module 510, and provide indications of whether a user is speaking.

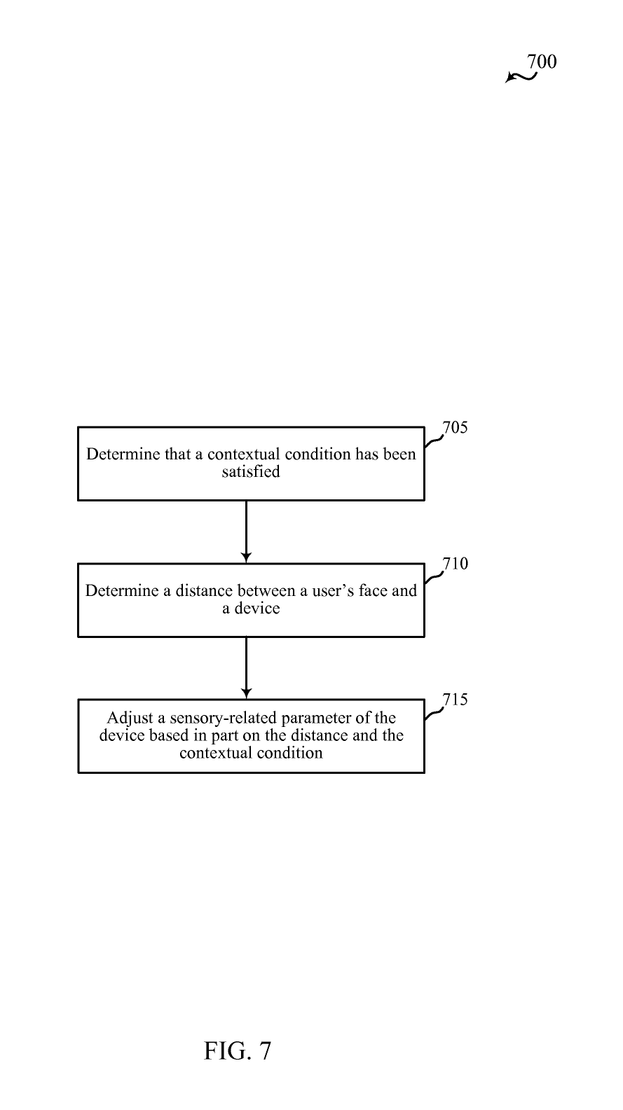

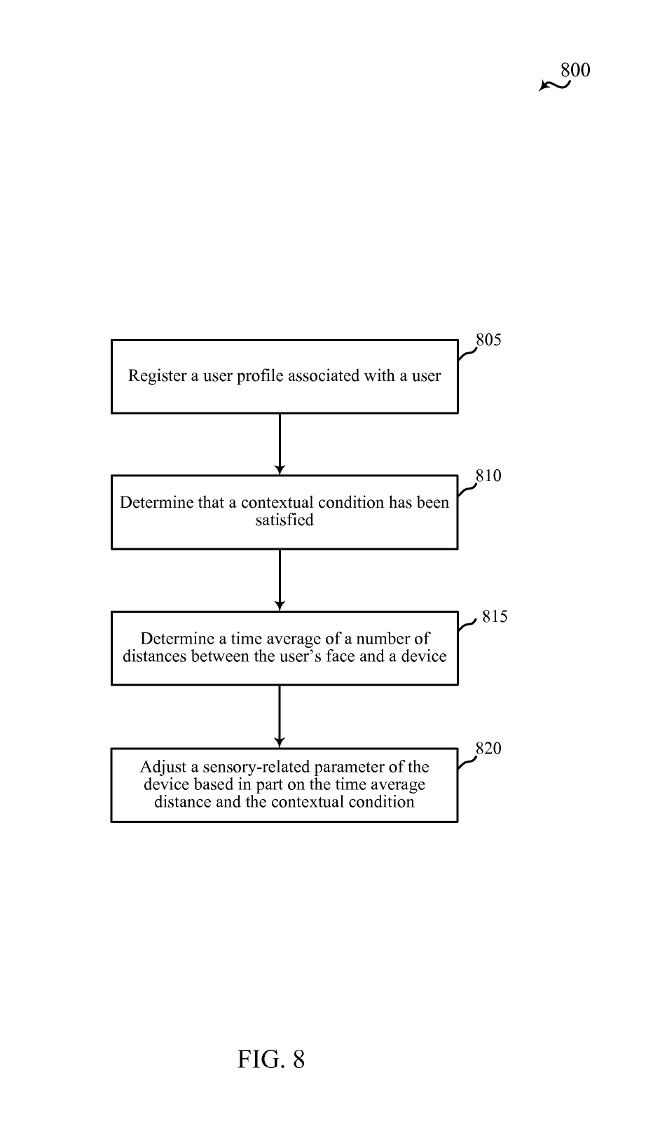

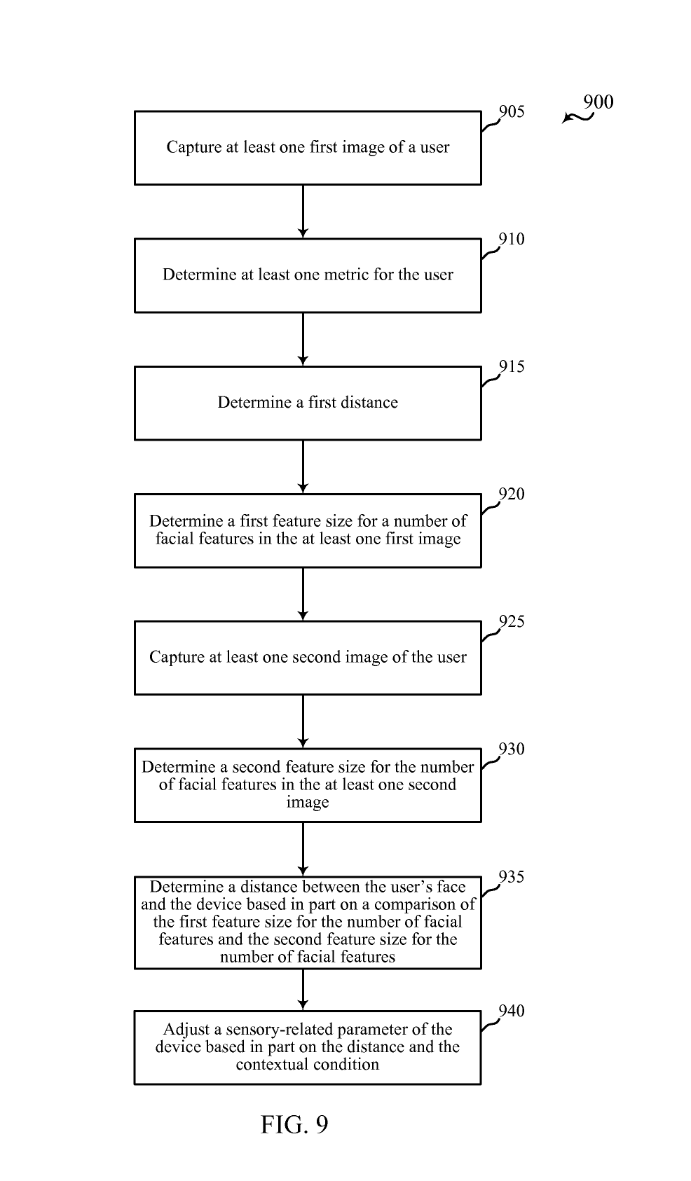

The device 115-d may be configured to implement aspects discussed above with respect to devices 115 of FIGS. 1, 2, 3A, 3B, 4A, and/or 4B, and may not be repeated here for the sake of brevity. Thus, sensor module 405-b may include the modules and functionality described above with reference to sensor module 405 of FIG. 4A and/or sensor module 405-a of FIG. 4B. Additionally or alternatively, sensor module 405-b may perform part or all of the method 700 described with reference to FIG. 7, the method 800 described with reference to FIG. 8, and/or the method 900 described with reference to FIG. 9. The I/O interface module 410-b may include the modules and functionality described above with reference to I/O interface module 410 of FIG. 4A and/or I/O interface module 410-a of FIG. 4B. Additionally or alternatively, I/O interface module 410-b may perform part or all of the method 700 described with reference to FIG. 7, the method 800 described with reference to FIG. 8, and/or the method 900 described with reference to FIG. 9. Further, the adjustment module 415-b may include the modules and functionality described above with reference to adjustment module 415 of FIG. 4A and/or adjustment module 415-a of FIG. 4B. Additionally or alternatively, adjustment module 415-b may perform part or all of the method 700 described with reference to FIG. 7, the method 800 described with reference to FIG. 8, and/or the method 900 described with reference to FIG. 9.

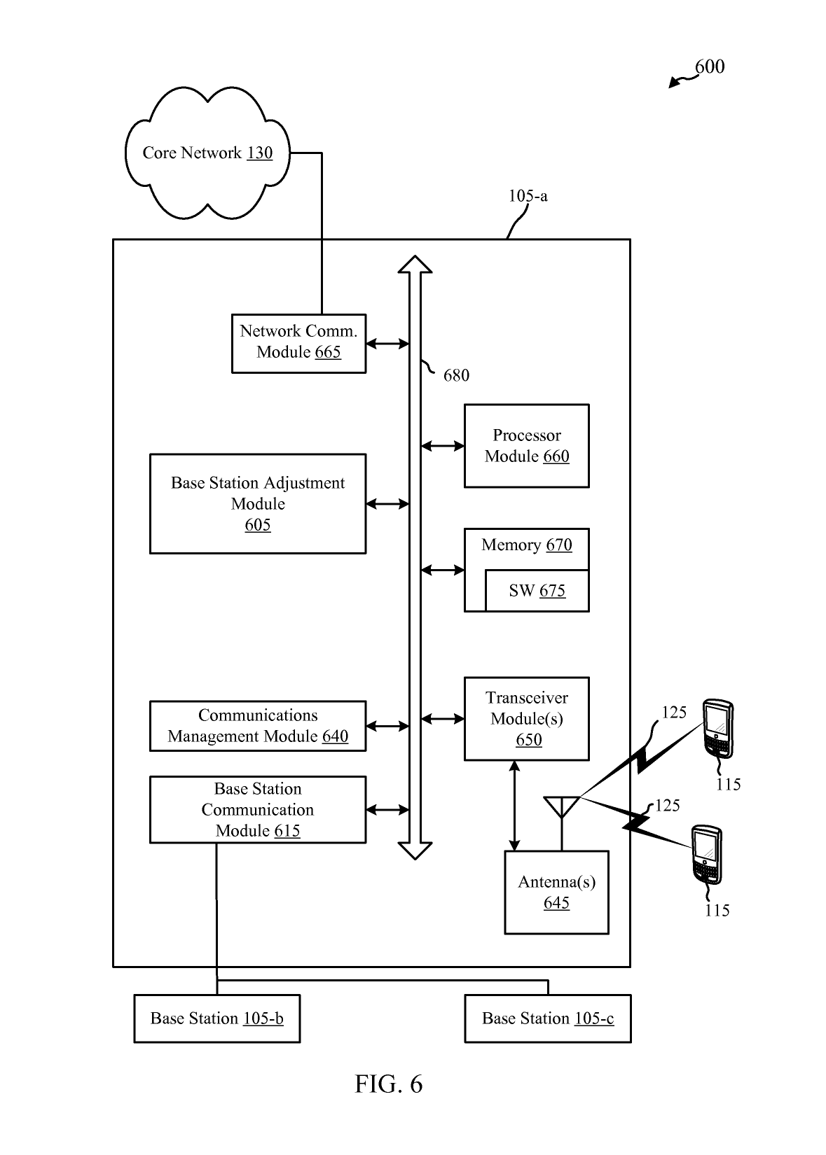

FIG. 6 shows a block diagram of a communications system 600 that may be configured for parameter adjustment in accordance with various aspects of the present disclosure. This system 600 may be an example of aspects of the systems 100, 200, 300, or 300-a depicted in FIG. 1, FIG. 2, FIG. 3A, or FIG. 3B. The system 600 includes a base station 105-a configured for communication with devices 115 over wireless communication links 125. The base station 105-a may be capable of communicating over one or more component carriers and may be capable of performing carrier aggregation using multiple component carriers for a communication link 125. The base station 105-a may be, for example, a base station 105 as illustrated in system 100.

In some cases, the base station 105-a may have one or more wired backhaul links. The base station 105-a may be, for example, an LTE eNB 105 having a wired backhaul link (e.g., S1 interface, etc.) to the core network 130. The base station 105-a may also communicate with other base stations, such as base station 105-b and base station 105-c via inter-base station communication links (e.g., X2 interface, etc.). Each of the base stations 105 may communicate with devices 115 using the same or different wireless communications technologies. In some cases, the base station 105-a may communicate with other base stations such as 105-b and/or 105-c utilizing base station communication module 615. In some examples, base station communication module 615 may provide an X2 interface within an LTE/LTE-A wireless communication network technology to provide communication between some of the base stations 105. In some examples, the base station 105-a may communicate with other base stations through the core network 130. In some cases, the base station 105-a may communicate with the core network 130 through network communications module 665.

The components for the base station 105-a may be configured to implement aspects discussed above with respect to base stations 105 of FIG. 1 and may not be repeated here for the sake of brevity. In some cases, the base station 105-a may include base station adjustment module 605. The base station adjustment module 605 may communicate parameter adjustment information with devices 105. In some cases, the base station adjustment module 605 may perform some or all of the functions of the adjustment module 415 of FIGS. 4A, 4B, and 5. The base station adjustment module 605 may perform the functions of the adjustment module 415 remotely, based on information, such as parameter adjustment information, received from the device 115. For example, the base station adjustment module 605 may determine when a contextual condition is satisfied, register a user profile, determine a distance between a device 115 and a user 110, determine parameters to adjust, and/or transmit information (e.g., which parameter to adjust and/or how much to adjust the parameter) to the device 115. In some cases, the base station adjustment module 605 includes a database. The base station adjustment module 605 may store information which may relate to parameter adjustment, such as user profile information, contextual condition information (e.g., which applications belong to application categories), parameter information, and/or information on how to adjust specific parameters.

The base station 105-a may include antennas 645, transceiver modules 650, memory 670, and a processor module 660, which each may be in communication, directly or indirectly, with each other (e.g., over bus system 680). The transceiver modules 650 may be configured to communicate bi-directionally, via the antennas 645, with the devices 115, which may be multi-mode devices. The transceiver module 650 (and/or other components of the base station 105-a) may also be configured to communicate bi-directionally, via the antennas 645, with other base stations (not shown). The transceiver module 650 may include a modem configured to modulate the packets and provide the modulated packets to the antennas 645 for transmission, and to demodulate packets received from the antennas 645. The base station 105-a may include multiple transceiver modules 650, each with at least one associated antenna 645.

The memory 670 may include random access memory (RAM) and read-only memory (ROM). The memory 670 may also store computer-readable, computer-executable software code 675 containing instructions that are configured to, when executed, cause the processor module 660 to perform various functions described herein (e.g., register a user profile, determine a contextual condition has been satisfied, determine a parameter to adjust, etc.). Alternatively, the software 675 may not be directly executable by the processor module 660 but be configured to cause the computer, e.g., when compiled and executed, to perform functions described herein.

The processor module 660 may include an intelligent hardware device, e.g., a central processing unit (CPU), a microcontroller, an application-specific integrated circuit (ASIC), etc. The processor module 660 may include various special purpose processors such as encoders, queue processing modules, base band processors, radio head controllers, digital signal processors (DSPs), and the like.

According to the architecture of FIG. 6, the base station 105-a may further include a communications management module 640. The communications management module 640 may manage communications with other base stations 105. The communications management module 640 may include a controller and/or scheduler for controlling communications with devices 115 in cooperation with other base stations 105. For example, the communications management module 640 may perform scheduling for transmissions to devices 115.

FIG. 7 shows a flow diagram that illustrates a method 700 for parameter adjustment in accordance with various aspects of the present disclosure. The method 700 may be implemented using, for example, the devices and systems 100, 200, 300, 300-a, 400, 400-a, 500, and 600 of FIGS. 1, 2, 3A, 3B, 4A, 4B, 5, and 6.

At block 705, a device 115 and/or base station 105 may determine that a contextual condition has been satisfied. For example, the operations at block 705 may be performed by the adjustment module 415 of FIG. 4A; the contextual condition module 425 of FIG. 4B; the device 500 of FIG. 5; and/or the device 600 of FIG. 6.

At block 710, a device 115 may determine a distance between a user's face and a device. For example, the operations at block 710 may be performed by the adjustment module 415 of FIG. 4A; the distance module 430 of FIG. 4B; the device 500 of FIG. 5, and/or the device 600 of FIG. 6.

At block 715, a device 115 and/or base station 105 may adjust a sensory-related parameter of the device based in part on the distance and the contextual condition. For example, the operations at block 715 may be performed by the adjustment module 415 of FIG. 4A; the parameter adjustment module 435 of FIG. 4B; the device 500 of FIG. 5; and/or the device 600 of FIG. 6.

FIG. 8 shows a flow diagram that illustrates a method 800 for parameter adjustment in accordance with various aspects of the present disclosure. The method 800 may be implemented using, for example, the devices and systems 100, 200, 300, 300-a, 400, 400-a, 500, and 600 of FIGS. 1, 2, 3A, 3B, 4A, 4B, 5, and 6.

At block 805, a device 115 and/or base station 105 may register a user profile associated with a user. For example, the operations at block 805 may be performed by the adjustment module 415 of FIG. 4A; the profile registration module 420 of FIG. 4B; the device 500 of FIG. 5; and/or the device 600 of FIG. 6.

At block 810, a device 115 and/or base station 105 may determine that a contextual condition has been satisfied. For example, the operations at block 810 may be performed by the adjustment module 415 of FIG. 4A; the contextual condition module 425 of FIG. 4B; the device 500 of FIG. 5; and/or the device 600 of FIG. 6.

At block 815, a device 115 may determine a time average of a number of distances between the user's face and a device. For example, the operations at block 815 may be performed by the adjustment module 415 of FIG. 4A; the distance module 430 of FIG. 4B; and/or the device 500 of FIG. 5.

At block 820, a device 115 and/or base station 105 may adjust a sensory-related parameter of the device based in part on the time average distance and the contextual condition. For example, the operations at block 820 may be performed by the adjustment module 415 of FIG. 4A; the parameter adjustment module 435 of FIG. 4B; the device 500 of FIG. 5; and/or the device 600 of FIG. 6.

FIG. 9 shows a flow diagram that illustrates a method 900 for parameter adjustment in accordance with various aspects of the present disclosure. The method 900 may be implemented using, for example, the devices and systems 100, 200, 300, 300-a, 400, 400-a, 500, and 600 of FIGS. 1, 2, 3A, 3B, 4A, 4B, 5, and 6.

At block 905, a device 115 may capture at least one first image of a user. For example, the operations at block 905 may be performed by the sensor module 405 of FIG. 4A; and/or the device 500 of FIG. 5.

At block 910, a device 115 and/or base station 105 may determine at least one metric for the user. For example, the operations at block 910 may be performed by the I/O interface module 410 or the adjustment module 415 of FIG. 4A; the profile registration module 420 of FIG. 4B; the device 500 of FIG. 5; and/or the device 600 of FIG. 6.

At block 915, a device 115 and/or base station 105 may determine a first distance. For example, the operations at block 915 may be performed by the adjustment module 415 of FIG. 4A; the distance module 430 of FIG. 4B; the device 500 of FIG. 5; and/or the device 600 of FIG. 6.

At block 920, a device 115 and/or base station 105 may determine a first feature size for a number of facial features in the at least one first image. For example, the operations at block 920 may be performed by the adjustment module 415 of FIG. 4A; the profile registration module 420 or the distance module 430 of FIG. 4B; the device 500 of FIG. 5; and/or the device 600 of FIG. 6.

At block 925, a device 115 may capture at least one second image of the user. For example, the operations at block 925 may be performed by the sensor module 405 of FIG. 4A; and/or the device 500 of FIG. 5.

At block 930, a device 115 and/or base station 105 may determine a second feature size for the number of facial features in the at least one second image. For example, the operations at block 930 may be performed by the adjustment module 415 of FIG. 4A; the distance module 430 of FIG. 4B; the device 500 of FIG. 5; and/or the device 600 of FIG. 6.

At block 935, a device 115 may determine a distance between the user's face and the device based in part on a comparison of the first feature size for the number of facial features and the second feature size for the number of facial features. For example, the operations at block 935 may be performed by the adjustment module 415 of FIG. 4A; the distance module 430 of FIG. 4B; and/or the device 500 of FIG. 5.

At block 940, a device 115 and/or base station 105 may adjust a sensory-related parameter of the device based in part on the distance and the contextual condition. For example, the operations at block 940 may be performed by the adjustment module 415 of FIG. 4A; the parameter adjustment module 435 of FIG. 4B; the device 500 of FIG. 5; and/or the device 600 of FIG. 6.

It will be apparent to those skilled in the art that the methods 700, 800, and 900 are but example implementations of the tools and techniques described herein. The methods 700, 800, and 900 may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. Although LTE and/or WLAN terminology is used in much of the description above, the described techniques are applicable beyond LTE or WLAN applications.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method of adjusting a sensory-related parameter of a device, comprising:
determining that a contextual condition has been satisfied;
determining a distance between a user's face and the device; and
adjusting the sensory-related parameter of the device based in part on the distance and the contextual condition.

2. The method of claim 1, wherein the sensory-related parameter of the device is adjusted linearly or logarithmically with respect to the distance.

3. The method of claim 1, wherein the sensory-related parameter is at least one of a display brightness, a screen resolution, a zoom, and a volume.

4. The method of claim 1, wherein determining the distance comprises:
determining a time average of a number of distances.

5. The method of claim 1, further comprising:
registering a user profile associated with the user.

6. The method of claim 5, wherein registering a user profile comprises:
capturing at least one first image of the user; and
determining at least one metric for the user.

7. The method of claim 6, wherein the at least one metric is at least one of a user designation and a size of at least one facial feature.

8. The method of claim 6, further comprising determining a first distance.

9. The method of claim 8, wherein determining the first distance is based in part on at least one of a sensor output and analysis of the at least one first image of the user.

10. The method of claim 8, further comprising determining a first feature size for a number of facial features in the at least one first image.

11. The method of claim 10, wherein determining the first feature size is based in part on a first number of pixels occupied by the facial feature.

12. The method of claim 10, wherein determining the distance between the user's face and the device comprises:
capturing at least one second image of the user;
determining a second feature size for the number of facial features in the at least one second image; and
determining the distance between the user's face and the device based in part on a comparison of the first feature size for the number of facial features and the second feature size for the number of facial features.

13. The method of claim 12, wherein comparing the first feature size for the number of facial features and the second feature size for the number of facial features is based in part on a weight associated with at least one of the number of facial features.

14. The method of claim 12, wherein determining the second feature size is based in part on a second number of pixels occupied by the facial feature.

15. The method of claim 5, wherein the contextual condition being satisfied comprises at least one of the user profile belonging to a profile category, interaction with an application belonging to an application category, and the distance between the user's face and the device being less than a threshold.

16. The method of claim 15, wherein the profile category comprises at least one user profile which is subject to sensory-related parameter adjustment.

17. The method of claim 15, wherein the application category comprises at least one application which is subject to sensory-related parameter adjustment.

18. A device having an adjustable sensory-related parameter, comprising:
means for determining that a contextual condition has been satisfied;
means for determining a distance between a user's face and the device; and
means for adjusting the sensory-related parameter of the device based in part on the distance and the contextual condition.

19. The device of claim 18, wherein the sensory-related parameter of the device is adjusted linearly or logarithmically with respect to the distance.

20. The device of claim 18, wherein the sensory-related parameter is at least one of a display brightness, a screen resolution, a zoom, and a volume.

21. The device of claim 18, wherein the means for determining the distance comprises:
means for determining a time average of a number of distances.

22. The device of claim 18, further comprising:
means for registering a user profile associated with the user.

23. The device of claim 22, wherein the means for registering a user profile comprise:
means for capturing at least one first image of the user; and
means for determining at least one metric for the user.

24. The device of claim 23, further comprising means for determining a first distance.

25. The device of claim 24, further comprising means for determining a first feature size for a number of facial features in the at least one first image.

26. The device of claim 25, wherein the means for determining the distance between the user's face and the device comprise:
means for capturing at least one second image of the user;
means for determining a second feature size for the number of facial features in the at least one second image; and
means for determining the distance between the user's face and the device based in part on a comparison of the first feature size for the number of facial features and the second feature size for the number of facial features.

27. The device of claim 26, wherein comparing the first feature size for the number of facial features and the second feature size for the number of facial features is based in part on a weight associated with at least one of the number of facial features.

28. The device of claim 22, wherein the contextual condition being satisfied comprises at least one of the user profile belonging to a profile category, interaction with an application belonging to an application category, and the distance between the user's face and the device being less than a threshold.

29. A device having an adjustable sensory-related parameter, comprising:
a processor;
memory in electronic communication with the processor; and
instructions stored in the memory, the instructions being executable by the processor to:
determine that a contextual condition has been satisfied;
determine a distance between a user's face and the device; and
adjust the sensory-related parameter of the device based in part on the distance and the contextual condition.

30. A non-transitory computer readable medium storing computer-executable code for adjusting a sensory-related parameter in a wireless device, the code executable by a processor to:
determine that a contextual condition has been satisfied;
determine a distance between a user's face and the device; and
adjust the sensory-related parameter of the device based in part on the distance and the contextual condition.
